(19) United States
(12) Patent Application Publication
(10) Pub. No.: US 2013/0081517 A1
(43) Pub. Date: Apr. 4, 2013

(54) Multi-head Ratchet Sleeve Spanner

(71) Applicant: Hao Wen, Shanghai (CN)

(72) Inventor: Hao Wen, Shanghai (CN)

(21) Appl. No.: 13/516,510

(22) PCT Filed: Dec. 15, 2010
(86) PCT No.: PCT/CN2010/002045

§ 371 Date: Nov. 5, 2012

(30) Foreign Application Priority Data
Dec. 24, 2009 (CN) 2009202861178.1

(51) Int. Cl. B25B 13/46; B25B 13/06

(52) U.S. Cl. CPC B25B 13/462; B25B 13/06
USPC 81/57.5; 81/60

(57) ABSTRACT

Embodiments of the present invention relate to a multi-socket ratchet wrench. The multi-socket ratchet wrench includes a handle, at least one ring-shaped ratchet wheel assembly, and at least one multi-socket assembly. The ring-shaped ratchet wheel assembly is coupled to the handle. The multi-socket assembly comprises at least two sockets integrated together. The sockets are rotatably connected to an inner side of the ring-shaped ratchet wheel. The multi-socket ratchet wrench according to embodiments of the present invention combines multiple sockets and ratchet wheels together thus have the functions of both multiple sockets and ratchet wheels. The advantages include compact in structure, and flexible and convenient to use.

### CROSS-REFERENCE TO RELATED APPLICATIONS

This application is the National Stage of International Application No. PCT/CN2010/002045 filed Dec. 15, 2010 and claims the benefit of CN application no. 200920286178.1 filed Dec. 24, 2009.

### FIELD OF THE INVENTION

Embodiments of the present invention generally relate to a hand tool. More particularly, embodiments of the present invention relate to a ratchet wrench having multiple sockets.

### DESCRIPTION OF THE RELATED ART

Socket wrenches are widely used in various situations. Structures of existing socket wrenches include a wrench body having a single socket hole formed at each end of the wrench body. Typically, the wrench body and a set of sockets are arranged in a box. To use, remove a socket and mount the socket on the wrench body. It usually requires multiple socket wrenches having different sizes to operate on different sized workpieces. Therefore, it is usually necessary to carry multiple socket wrenches during operation. Therefore, existing socket wrenches are incontinent to carry and have increased cost

In an attempt to solve the above problem, multi-socket socket wrenches appeared. In a multi-socket socket wrench, sockets of multiple dimensions are integrated together. For example, Chinese Patent Office Patent No. CN201519920U disclosed a multi-socket socket wrench including a wrench body, magnetic buckles embedded in the wrench body, and socket heads mounted on both ends of the wrench body. The wrench body has U-shaped grooves formed on both ends. Circular holes are formed in sidewalls of the U-shaped grooves. The socket heads are cross-shaped. Each end of the cross-shaped socket heads has a different socket holes. Circular holes are formed on two side surfaces of the socket head. Shaft pins are disposed in the circular holes of the socket heads and circular holes of in the sidewalls of the U-shaped grooves allowing the socket head to rotate about the shaft pins in the U-shaped grooves. V-shaped grooves are formed on the side surfaces of the socket heads outwards from the circular holes, corresponding to the socket holes. A small hole is formed on an inner side of the sidewall of the U-shaped groove. The small hole and an axis of the circular hole on the sidewall of the U-shaped groove form a 7-degree included angle. A spring and a steel ball are disposed in the small hoe. The multi-socket socket wrench solves the technical problems of high cost and inconvenience to carry. However, the structure of the multi-socket socket wrench is not compact or flexible for use, such as a ratchet wheel.

A ratchet mechanism is a one directional intermittent motion mechanism including a ratchet wheel and a pawl. Ratchet mechanisms are used in a variety of machine tools and automatic machines to provide intermittent feeding or to switch position in rotary tables. Ratchet mechanisms are also commonly used in jacks. Ratchet mechanisms are also commonly used in bikes to achieve one-way drive and in manual winch to prevent reversal. Outside mating ratchet mechanisms are commonly used. An outside mating ratchet mechanism includes a driving pendulum, a driving pawl, a ratchet wheel, a reversal-preventing pawl and a frame. The driving pendulum is coupled to a driven shaft fixed coupled to the ratchet wheel and is coupled to the driving pawl by revolute pairs. When the driving pendulum rotates clockwise, the driving pawl inserts into grooves of gears of the ratchet wheel to rotate the ratchet wheel by an angle while the reversal-preventing pawl slides along the back of the gears of the ratchet wheel. When the driving pendulum rotates counter clockwise, the reversal-preventing pawl prevents the ratchet wheel from rotating counter clockwise while the driving pawl slides along the back of the gears of the ratchet wheel. Thus, the ratchet wheel remains stationary. When the driving pendulum oscillates back and forth, the ratchet wheel makes one directional intermittent motion.

### SUMMARY OF THE INVENTION

Aimed to cure the defects in the current technology, embodiments of the present invention provide a multi-socket ratchet wrench, which is compact in structure and flexible and convenient to use.

One embodiment of the present invention provides a multi-socket ratchet wrench. The multi-socket ratchet wrench includes a handle and at least one ring-shaped ratchet wheel assembly. The ring-shaped ratchet wheel assembly is coupled to the handle. The multi-socket ratchet wrench further includes at least one multi-socket assembly. The multi-socket assembly comprises at least two sockets integrated together, the at least two sockets are distributed along the same circumference, and the multi-socket assembly is rotatably connected to an inner side of the ring-shaped ratchet wheel assembly via two short shaft pins.

The ring-shaped ratchet wheel includes a ratchet wheel cover, a ratchet wheel lid, a ratchet wheel, and a ratchet wheel adjusting mechanism. The ratchet wheel lid and the ratchet wheel cover are connected together and form a chamber configured to retain the ratchet wheel and the ratchet wheel adjusting mechanism. The chamber includes a ring-shaped portion and an outwardly extending connecting portion, the ratchet wheel is disposed in the ring-shaped portion. The ratchet wheel adjusting mechanism is disposed in the outwardly extending connecting portion, and the ratchet wheel adjusting mechanism is connected to the ratchet wheel to form a meshing transmission.

The multi-socket ratchet wrench further includes a connecting mechanism configured for mounting the multi-socket assemblies and disposed inside the ratchet wheel. A shaft hole is formed on each side of the multi-socket assembly, and the multi-socket assembly is rotatably connected to the ratchet wheel via two short shaft pins.

The multi-socket ratchet wrench further includes a first positioning assembly disposed in a contacting surface between the multi-socket assemblies and the ratchet wheel.

The ratchet wheel adjusting mechanism includes a ratchet wheel adjusting head, and a ratchet wheel adjusting switch. The ratchet wheel adjusting switch and the ratchet wheel adjusting head are connected by transmission.

The multi-socket ratchet wrench further includes a second positioning assembly disposed between the ratchet wheel adjusting switch and the ratchet wheel adjusting head.

Both the first positioning assembly and the second positioning assembly include a steel ball spring positioning assembly comprising a spring and a steel ball.

The multi-socket assembly includes six sockets evenly distributed along the same circumference, and the six sockets are of different dimensions.

The handle has two U-shaped fork openings disposed at two ends of the handle. The at least one ring-shaped ratchet wheel assembly includes two ring-shaped ratchet wheel assemblies. Each of the two one ring-shaped ratchet wheel assemblies is rotatably coupled to a corresponding U-shaped fork opening. The at least one multi-socket assembly includes two multi-socket assemblies. Each of the two multi-socket assemblies is rotatably coupled to a corresponding ring-shaped ratchet wheel assembly.

Each of the two multi-socket assemblies includes six sockets integrated thereon. The two multi-socket assemblies combined include twelve integrated sockets. The twelve sockets are of different dimensions.

Another embodiment of the present invention provides a multi-socket ratchet wrench. The multi-socket ratchet wrench includes a handle having at least one U-shaped fork opening disposed at one end of the handle. The multi-socket ratchet wrench also includes at least one ring-shaped ratchet wheel assembly. The ring-shaped ratchet wheel assembly is rotatably coupled to the U-shaped fork opening of the handle. The multi-socket ratchet wrench further includes at least one multi-socket assembly, at least one multi-socket assembly disposed thereon. The multi-socket assembly includes at least two sockets integrated together, the at least two sockets are distributed along the same circumference, and the multi-socket assembly is rotatably connected to an inner side of the ring-shaped ratchet wheel assembly via two short shaft pins.

Another embodiment of the present invention provides a multi-socket ratchet wrench. The multi-socket ratchet wrench includes a handle and at least one ring-shaped ratchet wheel assembly. The ring-shaped ratchet wheel assembly is coupled to the handle. The multi-socket ratchet wrench further includes at least one multi-socket assembly. The multi-socket assembly comprises at least two sockets integrated together. The sockets are rotatably connected to an inner side of the ring-shaped ratchet wheel.

Compared to the current technology, embodiments of the present invention provide the following advantages: the multi-socket ratchet wrenches according to embodiments of the present invention combine multiple sockets and ratchet wheels together thus having the advantages of both multiple sockets and ratchet wheels. The advantages include compact in structure, and flexible and convenient to use.

### BRIEF DESCRIPTION OF THE DRAWINGS

FIG. 1 is an exploded perspective view of a non-slop shield for an escalator according to present application.

FIG. 2 is a side view of a non-slop shield for an escalator according to present application.

### DETAILED DESCRIPTION

### Example One

The present invention provides a multi-socket ratchet wrench having a handle 1, ring-shaped ratchet wheel heads 2 and multi-socket assemblies 3. The handle 1 has at least one U-shaped fork openings 11. Each ring-shaped ratchet wheel assembly 2 is rotatably coupled to a U-shaped fork opening 11. The multi-socket assembly 3 is rotatably coupled to an inner side of the ring-shaped ratchet wheel assembly 2 via two short shaft pins 5. Each multi-socket assembly 3 includes at least 2 sockets integrated thereon and distributed along the same circumference.

Embodiments of the present invention are discussed in detail in connection with the Figures.

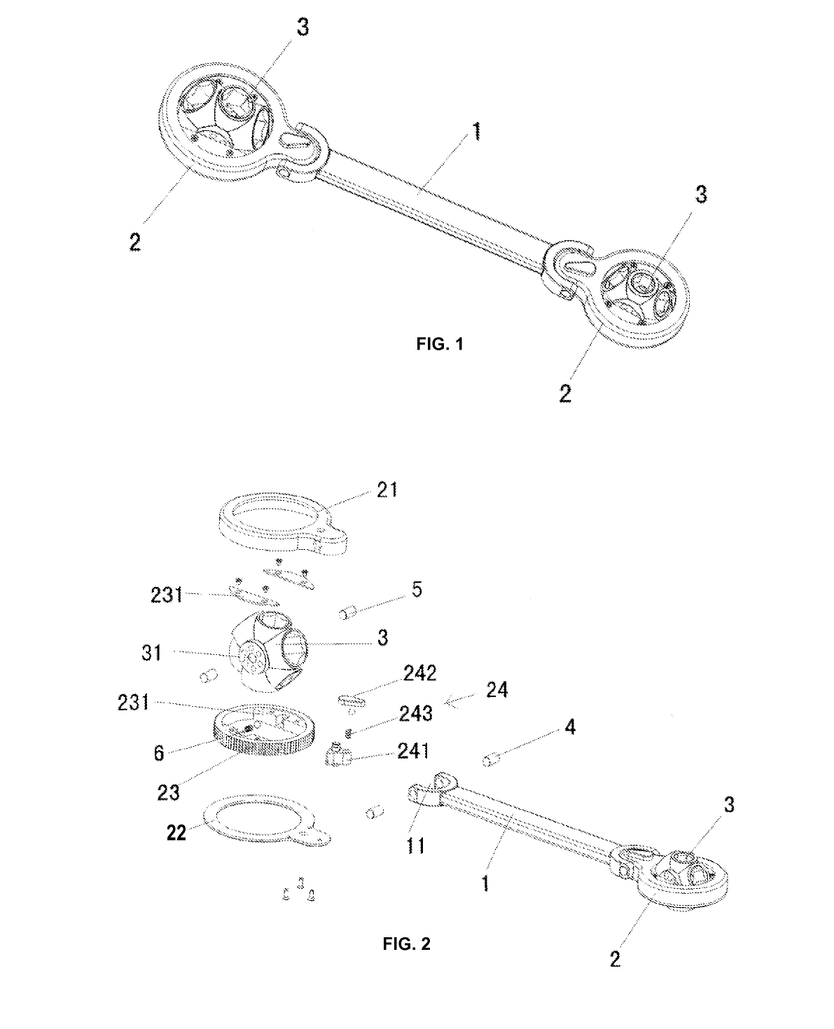

As shown in FIG. 1 and FIG. 2, the present embodiment provides a multi-socket ratchet wrench including the handle 1.

Each of two ends of the handle 1 is fixedly coupled to a U-shaped fork opening 11. A shaft hole is formed on each of two sides of the U-shaped fork opening 11.

One ring-shaped ratchet wheel assembly 2 is disposed at each of the two U-shaped fork openings 11 (one ring-shaped ratchet wheel assembly 2 is bigger and the other ring-shaped ratchet wheel assembly 2 is smaller). In this embodiment, the ring-shaped ratchet wheel assembly 2 is rotatably connected to the U-shaped fork opening 11 via two short shaft pins 4. The ring-shaped ratchet wheel assembly 2 includes a ratchet wheel cover 21, a ratchet wheel lid 22, a ratchet wheel 23, and a ratchet wheel adjusting mechanism 24. The ratchet wheel lid 22 and the ratchet wheel cover 21 are coupled together and form a chamber configured to retain the ratchet wheel 23 and the ratchet wheel adjusting mechanism 24. The chamber includes a ring-shaped portion and an outwardly extending connecting portion. The ratchet wheel 23 is disposed in the ring-shaped portion of the chamber and the ratchet wheel adjusting mechanism 24 is disposed in the outwardly extending connecting portion of the chamber. The ratchet wheel adjusting mechanism 24 is connected to the ratchet wheel 23 to form a mesh transmission. The outwardly extending connecting portion has two shaft holes. The ring-shaped ratchet wheel assembly 2 and the U-shaped fork opening 11 are connected by inserting the outwardly extending connecting portion inside the U-shaped fork opening 11 and inserting the two short shaft pins 4 into the shaft holes in both of the outwardly extending connecting portion and the U-shaped fork opening 11. The ratchet wheel adjusting mechanism 24 includes a ratchet wheel adjusting head 241 and a ratchet wheel adjusting switch 242. The ratchet wheel adjusting switch 242 is disposed above the outwardly extending connecting portion, and the ratchet wheel adjusting head 241 is disposed inside the outwardly extending connecting portion. The ratchet wheel adjusting switch 242 and the ratchet wheel adjusting head 241 are connected by transmission. A spring assembly 243 including steel balls are disposed between the ratchet wheel adjusting switch 242 and the ratchet wheel adjusting head 241.

One multi-socket assembly 3 is rotatably disposed inside each of the ring-shaped ratchet wheel assembly 2 (one of the two multi-socket assemblies 3 is bigger and the other one is smaller). In the present embodiment, each of the multi-socket assemblies 3 has six sockets evenly distributed along the same circumference. There are twelve sockets in total between the two multi-socket assemblies 3. The twelve sockets are of different size.

A connecting mechanism 231 configured for mounting the multi-socket assemblies 3 is disposed inside the ratchet wheel 23. A shaft hole 31 is formed on each side of the multi-socket assembly 3. The multi-socket assembly 3 is rotatably connected to the ratchet wheel 23 via two short shaft pins 5. A positioning assembly 6 including a spring with a steel ball may be disposed in the contacting surface between the multi-socket assemblies 3 and the ratchet wheel 23.

To use the ratchet wrench according the present invention, first rotate the multi-socket assembly 3 to select a socket of the right size; then press the ratchet wheel adjusting switch 242 and fit the socket around the workpiece to be tightened; rotate the ratchet wheel 23 along the direction for tightening, this is when an end surface of the ratchet wheel adjusting head 241 does not prevent the ratchet wheel 23 from rotating; at last, when the workpiece is tightened, remove the socket from the workpiece. When rotating the ratchet wheel 23 towards the opposite direction, the end surface of the ratchet wheel adjusting head 241 will press against the ratchet wheel 23 and prevent the ratchet wheel 23 from rotating.

### Example 2

Compared to Example 1, the ring-shaped ratchet wheel assembly and the handle may be connected via other connecting components. The ring-shaped ratchet wheel assembly and the handle may be fixedly connected, or ratably connected.

### Example 3

Compared to Example 1, the multi-socket assembly is not limited to be rotatably connected to the ring-shaped ratchet wheel assembly via the short shaft pins. The multi-socket assembly may be connected to the ring-shaped ratchet wheel assembly by any known connecting means.

While the foregoing is directed to exemplary embodiments, embodiments of the present invention are not limited to the above description. Other and further embodiments of the invention may be devised by persons skilled in the art without departing from the basic scope thereof and are also within the scope of the present invention.

1. A multi-socket ratchet wrench, comprising:
a handle;
at least one ring-shaped ratchet wheel assembly, wherein the ring-shaped ratchet wheel assembly is coupled to the handle; and
at least one multi-socket assembly, wherein the multi-socket assembly comprises at least two sockets integrated together, the at least two sockets are distributed along the same circumference, and the multi-socket assembly is rotatably connected to an inner side of the ring-shaped ratchet wheel assembly via two short shaft pins.

2. The multi-socket ratchet wrench of claim 1, wherein the ring-shaped ratchet wheel assembly is rotatably connected to the handle.

3. The multi-socket ratchet wrench of claim 1 or claim 2, wherein the ring-shaped ratchet wheel comprises:
a ratchet wheel cover;
a ratchet wheel lid;
a ratchet wheel; and
a ratchet wheel adjusting mechanism, wherein the ratchet wheel lid and the ratchet wheel cover are connected together and form a chamber configured to retain the ratchet wheel and the ratchet wheel adjusting mechanism, the chamber includes a ring-shaped portion and an outwardly extending connecting portion, the ratchet wheel is disposed in the ring-shaped portion, the ratchet wheel adjusting mechanism is disposed in the outwardly extending connecting portion, and the ratchet wheel adjusting mechanism is connected to the ratchet wheel to form a meshing transmission.

4. The multi-socket ratchet wrench of claim 1 or claim 2, further comprising a connecting mechanism configured for mounting the multi-socket assemblies and disposed inside the ratchet wheel, wherein a shaft hole is formed on each side of the multi-socket assembly, and the multi-socket assembly is rotatably connected to the ratchet wheel via two short shaft pins.

5. The multi-socket ratchet wrench of claim 1, further comprising a first positioning assembly disposed in a contacting surface between the multi-socket assemblies and the ratchet wheel.

6. The multi-socket ratchet wrench of claim 3, wherein the ratchet wheel adjusting mechanism comprises:
a ratchet wheel adjusting head; and
a ratchet wheel adjusting switch, wherein the ratchet wheel adjusting switch and the ratchet wheel adjusting head are connected by transmission.

7. The multi-socket ratchet wrench of claim 6, further comprising a second positioning assembly disposed between the ratchet wheel adjusting switch and the ratchet wheel adjusting head.

8. The multi-socket ratchet wrench of claim 7, further comprising a first positioning assembly disposed in a contacting surface between the multi-socket assemblies and the ratchet wheel, and
wherein both the first positioning assembly and the second positioning assembly comprise a steel ball spring positioning assembly comprising a spring and a steel ball.

9. The multi-socket ratchet wrench of claim 1, wherein the multi-socket assembly comprises six sockets evenly distributed along the same circumference, and the six sockets are of different dimensions.

10. The multi-socket ratchet wrench of claim 1 or claim 2, wherein the handle has two U-shaped fork openings disposed at two ends of the handle, the at least one ring-shaped ratchet wheel assembly comprises two ring-shaped ratchet wheel assemblies, each of the two one ring-shaped ratchet wheel assemblies is rotatably coupled to a corresponding U-shaped fork opening, the at least one multi-socket assembly comprises two multi-socket assemblies, and each of the two multi-socket assemblies is rotatably coupled to a corresponding ring-shaped ratchet wheel assembly.

11. The multi-socket ratchet wrench of claim 10, wherein each of the two multi-socket assemblies comprises six sockets integrated thereon, the two multi-socket assemblies combined comprise twelve integrated sockets, and the twelve sockets are of different dimensions.

12. A multi-socket ratchet wrench, comprising:
a handle, wherein at least one U-shaped fork opening is disposed at one end of the handle;
at least one ring-shaped ratchet wheel assembly, wherein the ring-shaped ratchet wheel assembly is rotatably coupled to the U-shaped fork opening of the handle; and
at least one multi-socket assembly disposed thereon, wherein the multi-socket assembly comprises at least two sockets integrated together, the at least two sockets are distributed along the same circumference, and the multi-socket assembly is rotatably connected to an inner side of the ring-shaped ratchet wheel assembly via two short shaft pins.

13. The multi-socket ratchet wrench of claim 12, wherein the ring-shaped ratchet wheel comprises:
a ratchet wheel cover;
a ratchet wheel lid;
a ratchet wheel; and
a ratchet wheel adjusting mechanism, wherein the ratchet wheel lid and the ratchet wheel cover are connected together and form a chamber configured to retain the ratchet wheel and the ratchet wheel adjusting mechanism, the chamber includes a ring-shaped portion and an outwardly extending connecting portion, the ratchet wheel is disposed in the ring-shaped portion, the ratchet wheel adjusting mechanism is disposed in the outwardly extending connecting portion, and the ratchet wheel adjusting mechanism is connected to the ratchet wheel to form a meshing transmission.

14. The multi-socket ratchet wrench of claim 12, further comprising:
a connecting mechanism configured for mounting the multi-socket assembly and disposed inside the ratchet wheel, wherein a shaft hole is formed on each side of the multi-socket assembly, and the multi-socket assembly is rotatably connected to the ratchet wheel via two short shaft pins; and
a positioning assembly disposed in a contacting surface between the multi-socket assembly and the ratchet wheel, wherein the positioning assembly comprises a spring and a steel ball.

15. The multi-socket ratchet wrench of claim 12, wherein the ratchet wheel adjusting mechanism comprises:
a ratchet wheel adjusting head;
a ratchet wheel adjusting switch, wherein the ratchet wheel adjusting switch and the ratchet wheel adjusting head are connected by transmission; and
a positioning assembly disposed between the ratchet wheel adjusting switch and the ratchet wheel adjusting head, wherein the positioning assembly comprises a spring and a steel ball.

16. The multi-socket ratchet wrench of claim 12, wherein the multi-socket assembly comprises six sockets integrated thereon, the six sockets are evenly distributed along the same circumference, and the six sockets are of different dimensions.

17. The multi-socket ratchet wrench of claim 12, wherein the handle has two U-shaped fork openings disposed at two ends of the handle, the at least one ring-shaped ratchet wheel assembly comprises two ring-shaped ratchet wheel assemblies, each of the two one ring-shaped ratchet wheel assembly is rotatably coupled to a corresponding U-shaped fork opening, the at least one multi-socket assembly comprises two multi-socket assemblies, and each of the two multi-socket assemblies is rotatably coupled to a corresponding ring-shaped ratchet wheel assembly.

18. The multi-socket ratchet wrench of claim 12, wherein the at least one multi-socket assembly comprises two multi-socket assemblies, and further wherein each of the two multi-socket assemblies comprises six sockets integrated thereon, the two multi-socket assemblies combined comprise twelve integrated sockets, and the twelve sockets are of different dimensions.

19. A multi-socket ratchet wrench, comprising:
a handle;
at least one ring-shaped ratchet wheel assembly, wherein the ring-shaped ratchet wheel assembly is coupled to the handle; and
at least one multi-socket assembly, wherein the multi-socket assembly comprises at least two sockets integrated together, and the sockets are rotatably connected to an inner side of the ring-shaped ratchet wheel.
